(19) United States
(12) Patent Application Publication
(10) Pub. No.: US 2002/0122389 A1
(43) Pub. Date: Sep. 5, 2002

(54) Start signal confirming/judging device for lan, signal confirming/judging method for lan, and recording medium in which a plurality of computer readable instructions are recorded

(76) Inventor: Koji Kobayashi, Shinagawa-ku (JP)

Correspondence Address: ROSENTHAL & OSHA L.L.P., 1221 MCKINNEY AVENUE, SUITE 2800, HOUSTON, TX, 77010, US

(21) Appl. No.: 09/947,628

(22) Filed: Sep. 6, 2001

(30) Foreign Application Priority Data
Mar. 5, 2001 (JP) 2001-060530

(51) Int. Cl. H04L 12/26; H04J 3/16

(52) U.S. Cl. 370/250; 370/296; 370/465; 340/815.4

(57) ABSTRACT

When a signal such as a normal link pulse signal outputted from a network apparatus is inputted to a physical device 16 via a first or a second connector 1, 2 and a pulse transformer 15, content of a predetermined register is set according to the inputted signal in the physical device 16, the content is read by a central processing circuit 52, and an operation mode of the network apparatus is judged so that either one of a first to a sixth LEDs 17 to 22 is lighted by the central processing circuit 52 via an LED display circuit 53 according to the result of the judgment and normality of the operation of the network apparatus and its operation mode can be confirmed/judged.

### BACKGROUND OF THE INVENTION

1. Field of the Invention

The present invention relates to a device for confirming a signal which is mutually transmitted/received among apparatuses configuring a LAN (Local Area Network) and performing other operations, and more particularly, to a device which facilitates and improves efficiency of confirming operations.

2. Description of the Related Art

Various standards for a so-called LAN (Local Area Network) are standardized according to difference in data transmitting rate and so on by the IEEE802 committee and so on.

In a LAN based on a standard which is standardized in this way, when individual apparatuses which are connected with each other by cables become mutually communicatable, data transmission/receipt is started after a predetermined signal designated in each standard is transmitted/received and normality thereof is confirmed.

When apparatuses constituting a LAN is to be mutually connected at the time a new LAN is configured, a LAN is expanded, and so on, it is sometimes necessary to confirm whether or not the predetermined signal as described above reaches input ends of the apparatuses without fail and for this signal confirmation, for example, an oscilloscope is usually used in most cases.

However, in various apparatuses constituting the LAN, a member such as a measuring terminal for confirming the predetermined signal is not usually provided, and therefore, even when an oscilloscope is to be used for confirming the predetermined signal, it is necessary to think of some way to carry out observation, such as terminating a resistor at a connector end of a cable which is connected to each of the apparatuses to make a pseudo-connected state, opening a case of the apparatus to press a probe of the oscilloscope against some appropriate place inside the apparatus, and so on, which consequently causes a disadvantage of complicating operations of confirming the signal.

### SUMMARY OF THE INVENTION

It is an object of the present invention to provide a signal confirming/judging device for LAN and a signal confirming/judging method for LAN which are capable of easily confirming whether or not a predetermined signal mutually transmitted/received among apparatuses configuring a LAN is normal, and a recording medium in which a plurality of computer readable instructions are recorded.

It is another object of the present invention to provide a signal confirming/judging device for LAN and a signal confirming/judging method for LAN which are capable of easily confirming an operation mode of the apparatuses configuring a LAN and a recording medium in which a plurality of computer readable instructions are recorded.

In order to achieve the above objects of the present invention, according to a first embodiment of the present invention, a signal confirming/judging device for LAN is provided, the device comprising: a network interface circuit structured to allow a predetermined signal to be inputted, which is outputted before data is transmitted/received among apparatuses constituting a LAN and is used for confirming a mutual operation state, and to set a binary data in a predetermined register according to a type of the inputted signal when the predetermined signal is inputted; a central processing circuit for inputting therein content of the predetermined register of the network interface circuit to judge an operation mode of each of the apparatuses which constitute the LAN and outputting a signal corresponding to a result of the judgment; and a display circuit for lighting a lighting element provided correspondingly to the operation mode of the apparatus which constitutes the LAN according to the signal outputted from the central processing circuit.

In the structure as described above, the signal outputted from the apparatus constituting the LAN is inputted so that the operation mode thereof is automatically judged by the central processing circuit to light the lighting element corresponding to the operation mode and consequently, it can be recognized visually at once whether or not the signal outputted from the apparatus constituting the LAN is normal and which operation mode it is in, which makes operations of connecting the apparatuses with each other easy and reliable.

As a more preferred embodiment of the present invention, a signal confirming/judging device for LAN is provided, wherein the network interface circuit is structured to set the binary data in the predetermined register when either of a normal link pulse signal, an idle signal, or an FLP burst signal is inputted therein, and wherein the central processing circuit is structured to operate in the following manner: to control the display circuit to light a first LED when it is judged based on the content of the predetermined register of the network interface circuit that the normal link pulse signal is received, which signifies that the network apparatus corresponds to a 10 BASE-T standard and a communication system thereof is in a half-duplex mode fixed state; to control the display circuit to light a second LED when it is judged based on the content of the predetermined register of the network interface circuit that the idle signal is received, which signifies that the network apparatus corresponds to a 100 BASE-TX standard and the communication system thereof is in the half-duplex mode fixed state; to control the display circuit to light a third LED when it is judged based on the content of the predetermined register of the network interface circuit that the FLP burst signal is received, which signifies that the network apparatus is in an auto-negotiation operation state, as well as when it is further judged based on the content of the register that the network apparatus corresponds to the 10 BASE-T standard and the communication system thereof is operable in the half-duplex mode; to control the display circuit to light a fourth LED when it is judged that based on the content of the predetermined register of the network interface circuit that the FLP burst signal is received, which signifies that the network apparatus is in an auto-negotiation operation state, as well as when it is further judged based on the content of the register that the network apparatus corresponds to the 10 BASE-T standard and the communication system thereof is operable in a full-duplex mode; to control the display circuit to light a fifth LED when it is judged based on the content of the predetermined register of the network interface circuit that the FLP burst signal is received, which signifies that the network apparatus is in an auto-negotiation operation state, as well as when it is further judged based on the content of the register that the network apparatus corresponds to the 100 BASE-TX standard and the communication system thereof is operable in the half-duplex mode; and to control the display circuit to light a sixth LED when it is judged based on the content of the predetermined register of the network interface circuit that the FLP burst signal is received, which signifies that the network apparatus is in an auto-negotiation operation state, as well as when it is further judged based on the content of the register that the network apparatus corresponds to the 100 BASE-TX standard and the communication system thereof is operable in the full-duplex mode.

Moreover, as a more preferred embodiment, a signal confirming/judging device for LAN is provided, the device comprising a first connector including a plurality of pins, a second connector including a plurality of pins, and changeover switches, and wherein the plural pins of the first connector and the plural pins of the second connector are wired/connected to shift between a straight connection and a cross connection via the changeover switches, wherein the straight connection connects predetermined pins defined in advance as pins for a transmitting signal in the first and the second connectors with each other while connecting predetermined pins defined in advance as pins for a receiving signal in the first and the second connectors with each other, wherein the cross connection connects the predetermined pins defined in advance as the pins for a transmitting signal in the first connector and the predetermined pins defined in advance as the pins for a receiving signal in the second connector while connecting the predetermined pins defined in advance as the pins for a receiving signal in the first connector and the predetermined pins defined in advance as the pins for a transmitting signal in the second connector, wherein terminal resistors are provided respectively between each of the predetermined pins which are defined in advance as the pins for a transmitting signal in the first or the second connector and between each of the predetermined pins which are defined in advance as the pins for a receiving signal in the first or the second connector so that connection states of the terminal resistors are changeable by opening/closing the terminal switches which are connected in series with the terminal resistors, and wherein respective waveform observing terminals are connected to respective wirings which connect the plural pins of the first connector and the plural pins of the second connector respectively.

Furthermore, in order to achieve the above objects of the present invention, according to a second embodiment of the present invention, a signal confirming/judging method for LAN for confirming/judging an operation mode of each of apparatuses constituting a LAN based on a predetermined signal which is outputted before data is transmitted/received among the apparatuses constituting the LAN and which is used for confirming a mutual operation state is provided, the method comprising the steps of: inputting the signal outputted from the apparatus constituting the LAN to judge whether the output signal is a normal link pulse signal, an idle signal, or an FLP burst signal; performing a predetermined first display when it is judged that the output signal is the normal link pulse signal, which signifies that the apparatus corresponds to a 10 BASE-T standard and a communication system thereof is in a half-duplex mode fixed state; performing a predetermined second display when it is judged that the output signal is the idle signal, which signifies that the apparatus corresponds to a 100 BASE-TX standard and the communication system thereof is in the half-duplex mode fixed state; further judging a mode in which the apparatus is operable based on content of the FLP burst signal when it is judged that the output signal is the FLP burst signal; performing, when it is judged in said step of judging that the apparatus corresponds to the 10 BASE-T standard and the communication system thereof is operable in the half-duplex mode, a predetermined third display, which indicates that the apparatus is operable in this operation mode in auto-negotiation; performing, when it is judged that the apparatus corresponds to the 10 BASE-T standard and the communication system thereof is operable in a full-duplex mode, a predetermined fourth display, which indicates that the apparatus is operable in this operation mode in the auto-negotiation; performing, when it is judged that the apparatus corresponds to the 100 BASE-TX standard and the communication system thereof is operable in the half-duplex mode, a predetermined fifth display, which indicates that the apparatus is operable in this operation mode in the auto-negotiation; and performing, when it is judged that the apparatus corresponds to the 100 BASE-TX standard and the communication system thereof is operable in the full-duplex mode, a predetermined sixth display, which indicates that the apparatus is operable in this operation mode in the auto-negotiation.

Furthermore, in order to achieve the above objects, according to a third embodiment of the present invention, provided is a recording medium in which a plurality of computer readable instructions are recorded, the plural instructions being readable by a microcomputer in a signal confirming/judging device for LAN comprising: a network interface circuit structured to allow a predetermined signal, which is outputted before data is transmitted/received among the apparatuses constituting the LAN and is used in confirming a mutual operation state, to be inputted therein, and to set a binary data in a predetermined register according to a type of the signal inputted therein when the predetermined signal is inputted; and the microcomputer for performing processing of judging an operation mode of each of the apparatuses which constitute the LAN based on content of the predetermined register of the network interface circuit, and being operable to cause the processing of judging the operation mode of each of the apparatuses constituting the LAN to be performed, the recording medium comprising: instruction means operable to cause the microcomputer to read the content of the predetermined register of the network interface circuit; instruction means operable to cause judgment to be made based on the content of the register whether the signal outputted from the apparatus constituting the LAN is a normal link pulse signal, an idle signal, or an FLP burst signal; instruction means operable to cause a signal to be outputted outside, the signal indicating that the apparatus constituting the LAN corresponds to a 10 BASE-T standard and a communication system thereof is in a half-duplex mode fixed state when the signal outputted from the apparatus constituting the LAN is judged to be the normal link pulse signal; instruction means operable to cause a signal to be outputted outside, the signal indicating that the apparatus constituting the LAN corresponds to a 100 BASE-TX standard and the communication system thereof is in the half-duplex mode fixed state when the signal outputted from the apparatus constituting the LAN is judged to be the idle signal; instruction means operable to further cause judgment of a mode in which the apparatus constituting the LAN is operable to be made based on the content of the predetermined register when the signal outputted from the apparatus constituting the LAN is judged to be the FLP burst signal; instruction means operable to cause, when the apparatus constituting the LAN is judged to correspond to the 10 BASE-T standard and the communication system thereof is judged to be operable in the half-duplex mode, a signal to be outputted outside, the signal indicating that the apparatus constituting the LAN is operable in this operation mode in auto-negotiation; instruction means operable to cause, when the apparatus constituting the LAN is judged to correspond to the 10 BASE-T standard and the communication system thereof is judged to be operable in a full-duplex mode, a signal to be outputted outside, the signal indicating that the apparatus constituting the LAN is operable in this operation mode in the auto-negotiation; instruction means operable to cause, when the apparatus constituting the LAN is judged to correspond to the 100 BASE-TX standard and the communication system thereof is judged to be operable in the half-duplex mode, a signal to be outputted outside, the signal indicating that the apparatus constituting the LAN is operable in this operation mode in the auto-negotiation; and instruction means operable to cause, when the apparatus constituting the LAN is judged to correspond to the 100 BASE-TX standard and the communication system thereof is judged to be operable in the full-duplex mode, a signal to be outputted outside, the signal indicating that the apparatus constituting the LAN is operable in this operation mode in the auto-negotiation.

### BRIEF DESCRIPTION OF THE DRAWINGS

FIG. 1 is a circuit diagram showing a circuit structure of a signal confirming/judging device for LAN according to an embodiment of the present invention;

FIG. 2 is a schematic view showing a connection state schematically when a waveform of a signal between a personal computer and a hub is observed using the signal confirming/judging device for LAN shown in FIG. 1;

FIG. 3 is a schematic view showing a connection state schematically when a waveform of a signal between two hubs is observed using the signal confirming/judging device for LAN shown in FIG. 1; and

FIG. 4 is a flow chart showing a series of processing procedures in the signal confirming/judging device for LAN when a signal outputted from a network apparatus is confirmed/judged using the signal confirming/judging device for LAN shown in FIG. 1.

### DETAILED DESCRIPTION OF THE PREFERRED EMBODIMENTS

The present invention is explained in detail below with reference to the attached drawings.

It is to be understood that members, arrangements, and so on which are explained below are not restrictive of the present invention and various improvements and modifications may be made within the scope and sprit of the present invention.

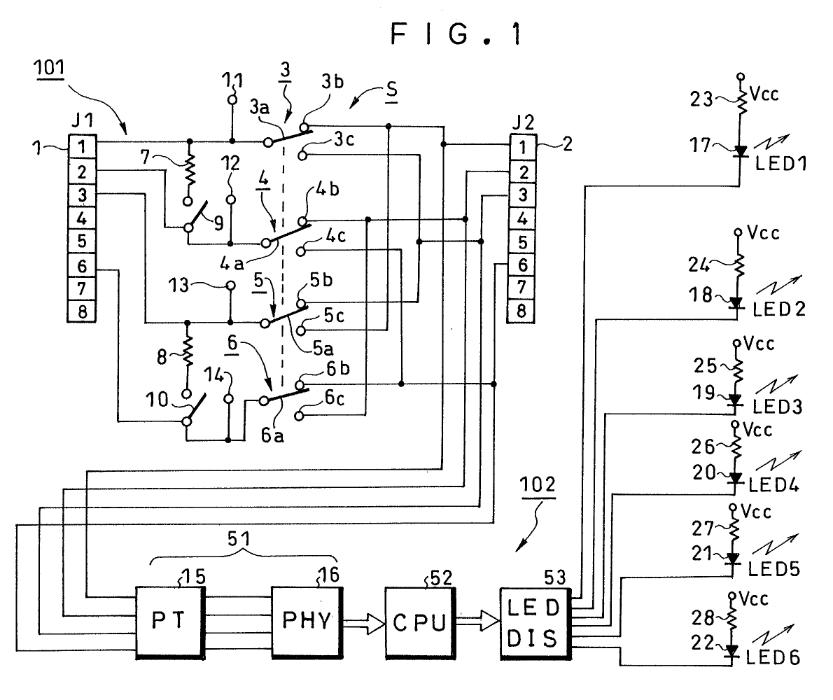

First, the structure of a signal confirming/judging device S for LAN according to an embodiment of the present invention (hereinafter referred to as the ‘present device’) is explained with reference to FIG. 1.

The present device S is appropriate for confirming a link pulse signal and so on (to be detailed later) which are used for confirming whether or not a mutual communication function is normal and for other purposes when mutual communication is started among individual apparatuses in a LAN (Local Area Network) (each of the apparatuses constituting the LAN is hereinafter referred to as a ‘network apparatus’) which corresponds to 10 BASE-T and 100 BASE-TX which are particularly defined in IEEE802.3.

The present device S is structured to be roughly divided to a waveform observing section 101 and a signal confirming/judging section 102.

The waveform observing section 101 is composed of first and second connectors 1, 2, first to fourth changeover switches 3 to 6 which change over connection states between the two connectors (to be described in detail later), first and second terminal resistors 7, 8, and first and second terminal switches 9, 10 as its main composing elements.

To be more specific, an 8 pin modular jack of an RJ-45 connector according to ISO8877 is appropriate for the first and second connectors (shown as ‘J1’, ‘J2’ in FIG. 1 respectively) 1, 2.

A circuit between the first and the second connectors 1, 2 is wired as described below. Specifically, a first pin of the first connector 1 is connected to a first changeover terminal 3a of the first changeover switch 3 and a first observing terminal 11 while being connected to one end of the first terminal resistor 7. The first changeover switch 3 is structured in a manner where the first changeover terminal 3a thereof can be selectively connected to a first contact 3b or a second contact 3c and it may be either a so-called mechanical switch or an electrical switch which is represented by a semiconductor switch using a semiconductor.

The first contact 3b of the first changeover switch 3 is connected to a first pin of the second connector 2 while being connected to a second contact 5c of the third changeover switch 5 and an input side of a pulse transformer (shown as ‘PT’ in FIG. 1) 15 which is described later.

The second contact 3c of the first changeover switch 3 is connected to a third pin of the second connector 2 while being connected to a first contact 5b of the third changeover switch 5 and the input side of the pulse transformer 15.

Another end of the aforesaid first terminal resistor 7 is connected to one end of the first terminal switch 9.

A second pin of the first connector 1 is connected to a changeover terminal 4a of the second changeover switch 4 and a second observing terminal 12 while being connected to another end of the first terminal switch 9 so that the first terminal resistor 7 is terminated between the first pin and the second pin of the first connector 1 when the first terminal switch 9 is closed. Incidentally, to be specific, a terminal resistor of 100 Ω is appropriate for the first and second terminal resistors 7, 8 since the present device S is expected to inspect a signal under a LAN environment of 10 BASE-T or 100 BASE-TX as previously mentioned.

Meanwhile, the second changeover switch 4 has a similar structure to that of the first changeover switch 3 which is described above, and a first contact 4b thereof is connected to a second pin of the second connector 2 while being connected to a second contact 6c of the fourth changeover switch 6 and the input side of the pulse transformer 15 which is described later.

A second contact 4c of the second changeover switch 4 is connected to a sixth pin of the second connector 2 while being connected to a first contact 6b of the fourth changeover switch 6 and the input side of the pulse transformer 15.

A third pin of the first connector 1 is connected to a changeover terminal 5a of the third changeover switch 5 which has a similar structure to that of the aforesaid first changeover switch 3 and a third observing terminal 13 while being connected to one end of the second terminal resistor 8 and another end of the second terminal resistor 8 is connected to one end of the second terminal switch 10.

A sixth pin of the first connector 1 is connected to a changeover terminal 6a of the fourth changeover switch 6 which has a similar structure to that of the aforesaid first changeover switch 3 and a fourth observing terminal 14 while being connected to another end of the second terminal switch 10. Therefore, when the second terminal switch 10 is closed, the second terminal resistor 8 can be terminated between the third and the sixth pins of the first connector 1.

The first to the fourth changeover switches 3 to 6 are structured to be opened/closed at the same time. Due to the connection as described above, when the respective changeover terminals 3a to 6a of the first to the fourth changeover switches 3 to 6 are connected to the respective first contacts 3b to 6b and the first and the second terminal switches 9, 10 are opened as shown in FIG. 1, a state in which the first, the second, the third, and the sixth pins of the first connector 1 and those of the second connector 2 are connected respectively with each other (this connection state is hereinafter referred to as a ‘straight connection state’) is made. Meanwhile, when the respective changeover terminals 3a to 6a of the first to the fourth changeover switches 3 to 6 are connected to the respective second contacts 3c to 6c and the first and the second terminal switches 9, 10 are opened, a state in which the first and second pins of the first connector 1 and the third and sixth pins of the second connector 2 are connected with each other respectively while the third and the sixth pins of the first connector 1 and the first and the third pins of the second connector 2 are connected with each other respectively (this connection state is hereinafter referred to as a ‘cross connection state’) is made.

As mentioned above, the RJ-45 connector is used for the first and the second connectors 1, 2 according to the embodiment of the present invention, and as is already known in general, the first and the second pins of the first and the second connectors 1, 2 in this case are pins which are defined as those for applying a so-called transmitting signal outputted from a network apparatus to outside and the third and the sixth pins of the first and the second connectors 1, 2 are pins which are defined as those for applying a so-called receiving signal received from outside by a network apparatus. In other words, the first and the second pins can be referred to as pins for a transmitting signal and the third and the sixth pins are pins for a receiving signal.

Meanwhile, the signal confirming/judging section 102 is structured to be roughly divided to a network interface circuit 51, a central processing circuit 52, and an LED display circuit 53 and is capable of confirming/judging whether or not the network apparatus is in a state in which it can normally transmit/receive data, based on existence and nonexistence of the predetermined signal as described below.

The network interface circuit 51 is composed of the pulse transformer 15 and a physical device 16 as its main composing elements.

The pulse transformer 15 is provided in order to secure electrical insulation between the network apparatus (not shown) which is connected to the present device S and the present device S. To be more specific, the pulse transformer 15 is a generally known transformer which is used on an input stage and so on of, for example, an NIC (Network Interface Card) according to 10 BASE-T and 100 BASE-TX specifications.

The physical device (shown as ‘PHY’ in FIG. 1) 16 is a physical layer LSI (Large Scale Integration) which has a generally known structure with a function of a physical layer of a so-called OSI reference model. To summarize the functions thereof, the physical device 16 receives a signal transmitted/received among the network apparatuses to judge which kind of signal the received signal is, set a bit of a predetermined register as ‘1’ when necessary, and so on and it allows a signal necessary for processing in a data link layer, which is a higher layer in the OSI reference model, to be outputted. The physical device 16 according to the embodiment of the present invention is used dedicatedly for judging in a central processing circuit 52 described next, based on data of the aforesaid register in the physical device 16, whether or not the predetermined signal is outputted from the network apparatus (to be detailed later).

The central processing circuit (shown as ‘CPU’ in FIG. 1) 52 controls operations of the present device S as a whole and controls the first to the six LEDs 17 to 22 to light via an LED display circuit (shown as ‘LED DIS’ in FIG. 1) 53 according to the result of judging the signal inputted to the present device S as described later. To be specific, it is preferred that the central processing circuit 52 is structured by using, for example, a so-called circuit-integrated microprocessor which is generally known.

The LED display circuit 53 is a circuit for appropriately selecting and lighting the first to the sixth LEDs (shown as ‘LED 1’, ‘LED 2’, ‘LED 3’, ‘LED 4’, ‘LED 5’, and ‘LED 6’ in FIG. 1) 17 to 22 according to a control signal from the central processing circuit 52.

Here, power supply voltage Vcc is applied to an anode of the first LED 17 via a resistor 23 for the first LED, to an anode of the second LED 18 via a resistor 24 for the second LED, to an anode of the third LED 19 via a resistor 25 for the third LED, to an anode of the fourth LED 20 via a resistor 26 for the fourth LED, to an anode of the fifth LED 21 via a resistor 27 for the fifth LED, and to an anode of the sixth LED 22 via a resistor 28 for the sixth LED. Meanwhile, electric potential of cathode sides of the first to the sixth LEDs 17 to 22 is controlled by the LED display circuit 53 and they are controlled to light when necessary as described later.

Power of the present device S may be supplied by a so-called battery to allow the present device S to be portable or may be supplied from a power source device for generating power supply voltage required for the present device S from commercial power source, and moreover, the present device S may have a structure in which both of them are usable. Incidentally, since this structure is a generally known circuit structure, specific explanations for the circuit structure are omitted here.

Next, a method of utilizing the present device S structured above, its operations, and so on are explained.

First, a method of observing a waveform of a signal by the waveform observing section 101 is explained with reference to FIG. 1 to FIG. 3.

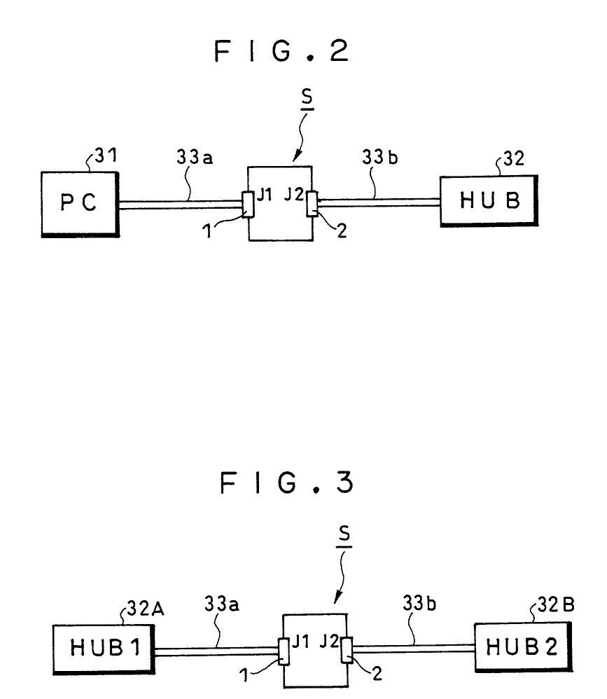

As a first example of observing the waveform of the signal, an example of observing the waveform of the signal transmitted/received among the network apparatuses which are connected with each other by so-called straight cables is first explained below with reference to FIG. 1 and FIG. 2, taking a case of waveform observation between a personal computer (PC) and a repeater set (a repeating apparatus), in other words, between a personal computer and so-called hub (HUB) as an example.

When the observation is to be started, the first to the fourth changeover switches 3 to 6 of the waveform observing section 101 are first changed over toward the sides of the first contacts 3b to 6b and the first and the second terminal switches 9, 10 are opened to make the straight connection state between the first connector 1 and the second connector 2 (refer to FIG. 1).

Thereafter, a personal computer 31 and the first connector 1 of the present device S are connected with each other by a first connection cable 33a while a hub 32 and the second connector 2 are connected with each other by a connection cable 33b (FIG. 2). The first and the second connection cables 33a, 33b used here are unshielded twisted pair cables (UTP) which are defined as cables to be used in a LAN of 10 BASE-T and 100 BASE-TX, and particularly, in this case, they are cables called UTP straight cables which are in a connection state where pins of connectors with the same pin number at both ends of the cables are connected with each other (a so-called straight state). Incidentally, to both ends of the first and the second connection cables 33a, 33b, connectors, that is, modular plugs (not shown) of RJ-45 connectors according to ISO08877, which fit in not shown RJ-45 connectors (modular jacks) of the first and the second connectors 1, 2 of the present device S, the personal computer 31, and the hub 32, are of course connected.

Next, the power supply voltage is supplied to the personal computer 31 and the hub 32 to put both of them in an operation state. When the observation is made between the first and the second observing terminals 11, 12 by an oscilloscope (not shown) in this state, a waveform of a signal transmitted to the hub 32 from the personal computer 31 can be observed. Meanwhile, when the observation is made between the third and the fourth observing terminals 13, 14 by the oscilloscope, a waveform of a signal transmitted to the personal computer 31 from the hub 32 can be observed.

Furthermore, when the signal outputted to the hub 32 from the personal computer 31 is to be observed in a resistance termination state, the first terminal switch 9 is first closed (FIG. 1) and the second connector 2 is then put into a state in which nothing is connected thereto while the personal computer 31 is connected to the first connector 1 via the first connection cable 33a. Incidentally, the first to the fourth changeover switches 3 to 6 may either be opened or closed in this case.

In this state, the waveform of the signal outputted from the personal computer 31 is observed in the resistance termination state in the first observing terminal 11.

Moreover, when the signal outputted to the personal computer 31 from the hub 32 is to be observed in the resistance termination state, the second terminal switch 10 is first closed while the first to the fourth changeover switches 3 to 6 are set toward the sides of the first contacts 3b to 6b. Then, the first connector 1 is put into a state in which nothing is connected thereto while the hub 32 is connected to the second connector 2 via the second connection cable 33b.

In this state, the waveform of the signal outputted from the hub 32 can be observed in the resistance termination state in the third observing terminal 13.

Incidentally, the waveform of the signal outputted to the personal computer 31 from the hub 32 can be also observed similarly in the third observing terminal 13 when the hub 32 is connected to the first connector 1 instead of the second connector 2. In this case, the first to the fourth changeover switches 3 to 6 may be in any setting states.

To be more specific, according to this embodiment of the present invention, the signal whose waveform is expected to be observed by the waveform observing section 101 is a normal link pulse signal in a network apparatus which constitutes a LAN of 10 BASE-T and whose communication system is in a half-duplex mode fixed state, and it is an idle signal in a network apparatus which constitutes a LAN of 100 BASE-TX and whose communication system is in the half-duplex mode fixed state. In a network apparatus having an auto-negotiation function, it is an FLP (fast link pulse) burst signal. All of these signals are signals which are mutually transmitted among the network apparatuses in order to confirm whether or not they are mutually communicatable before the network apparatuses transmit/receive data to/from each other. Since these signals are defined by IEEE802.3 in detail, detailed explanations thereof are omitted here.

Next, an example of observing the waveform of the signal which is transmitted/received among the network apparatuses which are connected with each other by so-called cross cables is explained below as a second example of observing the waveform of the signal with reference to FIG. 1 and FIG. 3, taking a case of observing the waveform between the hubs as an example. Incidentally, since specific signals in examples described below are also the same with those explained in the above first example, detailed explanations thereof are omitted.

In FIG. 3, a connection state of the present device S and two hubs (shown as ‘HUB 1’ and ‘HUB 2’ respectively in FIG. 3) 32A, 32B is schematically shown. First, before the present device S is connected to the first and the second hubs 32A, 32B, the first and 1, the second terminal switches 9, 10 are opened and the first to the fourth changeover switches 3 to 6 are put into a state in which they are set toward the sides of the second contacts 3c to 6c thereof to make the cross connection state (refer to FIG. 1).

Next, the first hub 32A and the second hub 32B are connected to the first connector of the present device S by the first connection cable 33a and to the second connector 2 of the present device S by the second connection cable 33b respectively (refer to FIG. 3). Then, the first and the second hubs 32A, 32B are put into an operation state.

When the observation is carried out between the first and the second observing terminals 11, 12 in this state by the oscilloscope (not shown), a waveform of a signal outputted to the second hub 32B from the first hub 32A can be observed.

When the observation is carried out between the third and the fourth observing terminals 13, 14 by the oscilloscope, a waveform of a signal outputted to the first hub 32A from the second hub 32B can be observed.

Next, a case where a signal outputted to the second hub 32B from the first hub 32A (or a signal outputted to the first hub 32A from the second hub 32B) is observed in the resistance termination state is explained. In this case, the first terminal switch 9 is first closed and then, the first hub 32A (or the second hub 32B) is connected to the first connector 1 via the first connection cable 33a while the second connector 2 is put into a state in which nothing is connected thereto. Incidentally, in this case, the first to the fourth changeover switches 3 to 6 may be set in any states.

When the first hub 32A (or the second hub 32B) is put into an operation state thereafter, the waveform of the signal outputted from the first hub 32A (or the signal outputted from the second hub 32B) can be observed in the resistance termination state in the first observing terminal 11.

Note that the waveform of the signal outputted to the first hub 32A from the second hub 32B can also be observed in the resistance termination state in the following way.

The second terminal switch 10 is first closed while the first to the fourth changeover switches 3 to 6 are put into a state in which they are set toward the sides of the second contacts 3c to 6c to make the cross connection state. Next, the first connector 1 is put into a state in which nothing is connected thereto while the second hub 32B is connected to the second connector 2 via the second connection cable 33b.

When the second hub 32B is put into an operation state thereafter, the observation of the waveform of the signal outputted from the second hub 32B in the resistance termination state is made possible in the third observing terminal 13.

Next, operations of the signal confirming/judging section 102 are explained with reference to FIG. 1 to FIG. 4.

When an output signal of a network apparatus is to be confirmed/judged by the signal confirming/judging section 102, the first and the second terminal switches 9, 10 are first opened (refer to FIG. 1). Next, the network apparatus (not shown) whose output signal is to be confirmed/judged is connected to the first connector 1 or the second connector 2. When it is connected to the first connector 1, the first to the fourth changeover switches 3 to 6 are set toward the sides of the first contacts 3b to 6b, and when it is connected to the second connector 2, the first to the fourth changeover switches 3 to 6 may be set in any way.

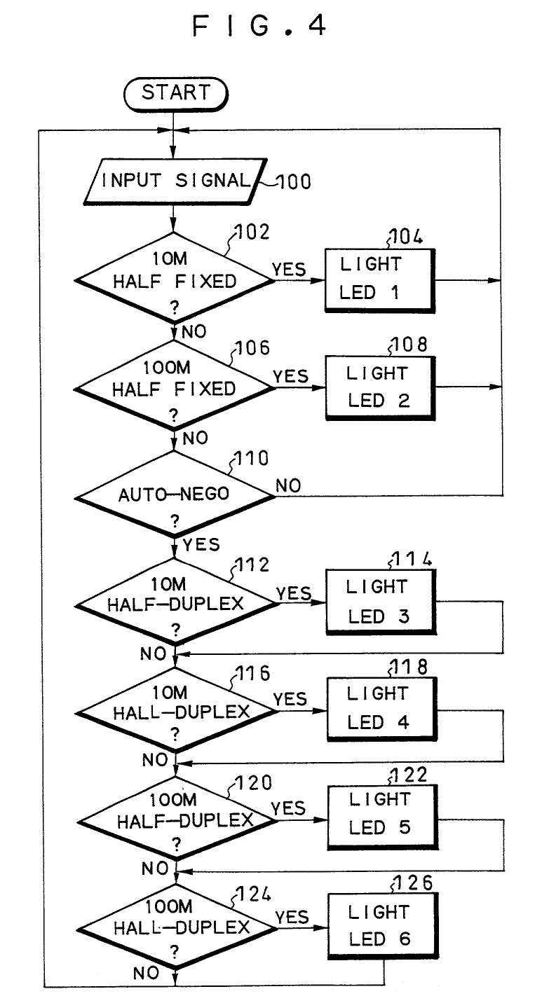

Then, the network apparatus which is not shown is put into an operation state and the present device S is also put into an operation state so that operation control by the central processing circuit 52 is started and a signal input is first performed (refer to a step 100 in FIG. 4). In other words, the signal outputted from the network apparatus which is not shown is inputted to the pulse transformer 15 via the first connector 1 or the second connector 2 and then inputted to the physical device 16 via the pulse transformer 15.

More specifically, a signal which is assumed as the signal inputted to the present device S from the network apparatus is the normal link pulse signal in the network apparatus which constitutes the LAN of 10 BASE-T and whose communication system is in the half-duplex mode fixed state and it is the idle signal in the network apparatus which constitutes the LAN of 100 BASE-TX and whose communication system is in the half-duplex mode fixed state. It is the FLP burst signal in the network apparatus which has the auto-negotiation function. All of these signals are signals which are mutually transmitted in order to confirm whether or not they are communicatable with each other before the network apparatuses transmit/receive data with each other. These signals are defined by IEEE802.3 in detail and therefore, detailed explanations thereof are omitted here.

When either one of the above signals is received, the bit of the predetermined register is set in the physical device 16 at a predetermined value, for example, ‘1’, according to the received signal. In the central processing circuit 52, content of the predetermined register of the physical device 16 is read at a predetermined timing, and it is first judged based on the content of the register whether or not the network apparatus (not shown) which is connected to the present device S corresponds to the 1) BASE-T standard and the communication system thereof is in the half-duplex mode fixed state (refer to a step 102 in FIG. 4). Note that ‘10M HALF FIXED’ in the step 102 in FIG. 4 indicates that the network apparatus corresponds to the 10 BASE-T standard and the communication system thereof is in the half-duplex mode fixed state, and more particularly, ‘10M’ indicates data transmission rate 10 Mbps in the 10 BASE-T and ‘HALF FIXED’ indicates the half-duplex mode fixed state of communication systems.

When it is judged in the processing of the step 102 that the network apparatus corresponds to the 10 BASE-T standard and the communication system thereof is in the half-duplex mode fixed state (YES), a control signal for lighting the first LED 17 is outputted from the central processing circuit 52 to the LED display circuit 53 and as a result, the first LED 17 is lighted by the LED display circuit 53 and the procedure returns to the previous step 100 (refer to a step 104 in FIG. 4).

Meanwhile, when it is not judged in the processing of the step 102 that the network apparatus corresponds to the 10 BASE-T standard as well as the communication system thereof is in the half-duplex mode fixed state (NO), it is judged whether or not the network apparatus corresponds to a 100 BASE-TX standard and the communication system thereof is in the half-duplex mode fixed state (refer to a step 106 in FIG. 4). Note that ‘100M HALF FIXED’ in the step 106 in FIG. 4 indicates that the network apparatus corresponds to the 100 BASE-TX standard and the communication system thereof is in the half-duplex mode fixed state, and more particularly, ‘100M’ indicates data transmission rate 100 Mbps in the 100 BASE-TX and ‘HALF FIXED’ indicates the half-duplex mode fixed state of communication systems.

When it is judged in the processing of the step 106 that the network apparatus corresponds to the 100 BASE-TX standard and the communication system thereof is in the half-duplex mode fixed state (YES), a control signal for lighting the second LED 18 is outputted from the central processing circuit 52 to the LED display circuit 53 and as a result, the second LED 18 is lighted by the LED display circuit 53 and the procedure returns to the previous step 100 (refer to a step 108 in FIG. 4).

Meanwhile, when it is not judged in the processing of the step 106 that the network apparatus corresponds to the 100 BASE-TX standards as well as the communication system thereof is in the half-duplex mode fixed state (NO), it is judged whether or not the network apparatus has the auto-negotiation function (refer to a step 110 in FIG. 4).

When it is judged thereafter in the processing of the step 110 that the network apparatus does not have the auto-negotiation function (NO), the procedure returns to the previous step 100 to repeat a series of the processing again. Meanwhile, when it is judged that the network apparatus has the auto-negotiation function (YES), it is further judged based on the content of the predetermined register of the physical device 16 whether or not the network apparatus corresponds to the 10 BASE-T standard and the communication system thereof is operable in the half-duplex mode (refer to a step 112 in FIG. 4). Note that ‘10M HALF-DUPLEX’ in the step 112 in FIG. 4 indicates that the network apparatus corresponds to the 10 BASE-T standard and the communication system thereof is operable in the half-duplex mode and more particularly, ‘10M’ indicates the data transmission rate 10 Mbps in the 10 BASE-T and ‘HALF-DUPLEX’ indicates the half-duplex mode of communication systems.

When it is not judged in the processing of the step 112 that the network apparatus corresponds to the 10 BASE-T standard as well as the communication system thereof is operable in the half-duplex mode (NO), the procedure proceeds to a step 116 which is described next (refer to the step 112 in FIG. 4). Meanwhile, when it is judged that the network apparatus corresponds to the 10 BASE-T standard and the communication system thereof is operable in the half-duplex mode (YES), a control signal for lighting the third LED 19 is outputted from the central processing circuit 52 to the LED display circuit 53 and as a result, the third LED 19 is lighted by the LED display circuit 53 and the procedure proceeds to the next step 116 (refer to a step 114 in FIG. 4).

In the processing of the step 116, it is judged whether or not the network apparatus corresponds to the 10 BASE-T standard and the communication system thereof is operable in a full-duplex mode. Note that ‘10M FULL-DUPLEX’ in the step 116 in FIG. 4 indicates that the network apparatus corresponds to the 10 BASE-T standard and the communication system thereof is operable in the full-duplex mode and more particularly, ‘10M’ indicates the data transmission rate 10 Mbps in the 10 BASE-T and ‘FULL-DUPLEX’ indicates the full-duplex mode of communication systems.

Then, when it is not judged in the processing of the step 116 that the network apparatus corresponds to the 10 BASE-T standard as well as the communication system thereof is operable in the full-duplex mode (NO), the procedure proceeds to the processing of a step 120 which is described next. Meanwhile, when it is judged that the network apparatus corresponds to the 10 BASE-T standard and the communication system thereof is operable in the full-duplex mode (YES), a control signal for lighting the fourth LED 20 is outputted from the central processing circuit 52 to the LED display circuit 53 and as a result, the fourth LED 20 is lighted by the LED display circuit 53 and the procedure proceeds to the processing of the next step 120 (refer to a step 118 in FIG. 4).

In the processing of the step 120, it is judged whether or not the network apparatus corresponds to the 100 BASE-TX standard and the communication system thereof is operable in the half-duplex mode. Note that ‘100M HALF-DUPLEX’ in the step 120 in FIG. 4 indicates that the network apparatus corresponds to the 100 BASE-TX standard and the communication system thereof is operable in the half-duplex mode and more particularly, ‘100M’ indicates the data transmission rate 100 Mbps in the 100 BASE-TX and ‘HALF-DUPLEX’ indicates the half-duplex mode of communication systems.

Then, when it is not judged in the processing of the step 120 that the network apparatus corresponds to the 100 BASE-TX standard as well as the communication system thereof is operable in the half-duplex mode (NO), the procedure proceeds to the processing of a step 124 which is described next. Meanwhile, when it is judged that the network apparatus corresponds to the 100 BASE-TX standard and the communication system thereof is operable in the half-duplex mode (YES), a control signal for lighting the fifth LED 21 is outputted from the central processing circuit 52 to the LED display circuit 53 and as a result, the fifth LED 21 is lighted by the LED display circuit 53 and the procedure proceeds to the processing of the next step 124 (refer to a step 122 in FIG. 4).

In the processing of the step 124, it is judged whether or not the network apparatus corresponds to the 100 BASE-TX standard and the communication system thereof is operable in the full-duplex mode. Note that ‘100M FULL-DUPLEX’ in the step 124 in FIG. 4 indicates that the network apparatus corresponds to the 100 BASE-TX standard and the communication system thereof is operable in the full-duplex mode and more particularly, ‘100M’ indicates the data transmission rate 100 Mbps in the 100 BASE-TX and ‘FULL-DUPLEX’ indicates the full-duplex mode of communication systems.

Then, when it is not judged in the processing of the step 124 that the network apparatus corresponds to the 100 BASE-TX standard as well as the communication system thereof is operable in the full-duplex mode (NO), the procedure returns to the previous step 100 to repeat a series of the processing again. Meanwhile, when it is judged that the network apparatus corresponds to the 100 BASE-TX standard and the communication system thereof is operable in the full-duplex mode (YES), a control signal for lighting the sixth LED 22 is outputted from the central processing circuit 52 to the LED display circuit 53 and as a result, the sixth LED 22 is lighted by the LED display circuit 53 and a series of the processing is finished and the procedure returns to the previous step 100 (refer to a step 126 in FIG. 4).

Incidentally, either of the third to the sixth LEDs 19 to 22 out of the first to the sixth LEDs 17 to 22 is lighted when the network apparatus has the auto-negotiation function as is seen from the operations described above and therefore, it is preferred that some consideration is given to a physical arrangement of the first and second LEDs 17, 18 and the third to sixth LEDs 19 to 22 and to display characters and so on which are displayed near the first to the six LEDs 17 to 22 on a surface of a not shown casing of the present device S so that it can be recognized visually with ease whether or not the network apparatus connected to the present device S has the auto-negotiation function.

For example, as the physical arrangement, it is appropriate that a wider space is taken between the first and second LEDs 17, 18 and the third to sixth LEDs 19 to 22 than spaces between each of the LEDs so that distinction between lighting of the first LED 17 or the second LED 18 and lighting of either one of the third to sixth LEDs 19 to 20 can be recognized at once. Moreover, it is also appropriate that character display, for example, ‘Auto-Nego’ is given near the third to sixth LEDs 19 to 22.

In the above-described embodiments, the explanations are made supposing that a signal confirming/judging program for LAN is stored in advance in an appropriate storage area of the central processing circuit 52 to execute the signal confirming/judging processing for LAN which is explained referring to FIG. 4, but the signal confirming/judging program for LAN is not, of course, limited to be stored in the central processing circuit 52.

In other words, the program may be stored in a generally known recording medium which is separately provided from the central processing circuit 52 to be read in the central processing circuit 52 from the recording medium when the signal confirming/judging processing for LAN is executed. As such a recording medium, a so-called magnetic recording medium which is represented by a flexible disc, a hard disc, a magnetic tape, and so on, an optical recording medium such as an optical disc, a magneto-optic recording medium, and so on are appropriate. Depending on which recording medium is utilized, it is of course necessary to provide a special device for the recording medium which reads and writes data and in this case, the device only has to be connected to the central processing circuit 52.

As described above, according to the present invention, the signal outputted from the apparatus which constitutes the LAN is inputted and a type of the signal can be judged automatically so that it is recognized whether or not the signal outputted by the apparatus which constitutes the LAN is normal and which operation mode it has. Particularly, lighting display according to a judged operation mode is performed so that the operation mode can be recognized visually at once, which brings about an effect of making operations of connecting the apparatuses easy and reliable.

Furthermore, due to the structure in which the connectors to which the apparatus constituting the LAN can be connected are provided and the terminals for observing the waveform of the signal and also the terminal resistors are provided, effects that the waveform of the signal outputted by the apparatus can be observed very easily and efficiency of the operations at the time of testing operations of the apparatus and so on is improved are brought about, which are not obtained conventionally.

What is claimed is:

1. A signal confirming/judging device for LAN, comprising:
a network interface circuit structured to allow a predetermined signal to be inputted, which is outputted before data is transmitted/received among apparatuses constituting a LAN and is used for confirming a mutual operation state, and to set a binary data in a predetermined register according to a type of the inputted signal when the predetermined signal is inputted;
a central processing circuit for inputting therein content of the predetermined register of said network interface circuit to judge an operation mode of each of the apparatuses which constitute the LAN and outputting a signal corresponding to a result of the judgment; and
a display circuit for lighting a lighting element provided correspondingly to the operation mode of the apparatus which constitutes the LAN according to the signal outputted from said central processing circuit.

2. A signal confirming/judging device for LAN according to claim 1,
wherein said network interface circuit is structured to set the binary data in the predetermined register when either of a normal link pulse signal, an idle signal, or an FLP burst signal is inputted therein, and
wherein said central processing circuit is structured to operate in the following manner:
to control said display circuit to light a first LED when it is judged based on the content of the predetermined register of said network interface circuit that the normal link pulse signal is received, which signifies that the network apparatus corresponds to a 10 BASE-T standard and a communication system thereof is in a half-duplex mode fixed state;
to control said display circuit to light a second LED when it is judged based on the content of the predetermined register of said network interface circuit that the idle signal is received, which signifies that the network apparatus corresponds to a 100 BASE-TX standard and the communication system thereof is in the half-duplex mode fixed state;
to control said display circuit to light a third LED when it is judged based on the content of the predetermined register of said network interface circuit that the FLP burst signal is received, which signifies that the network apparatus is in an auto-negotiation operation state, as well as when it is further judged based on the content of the register that the network apparatus corresponds to the 10 BASE-T standard and the communication system thereof is operable in the half-duplex mode;
to control said display circuit to light a fourth LED when it is judged based on the content of the predetermined register of said network interface circuit that the FLP burst signal is received, which signifies that the network apparatus is in an auto-negotiation operation state, as well as it is further judged based on the content of the register that the network apparatus corresponds to the 10 BASE-T standard and the communication system thereof is operable in a full-duplex mode;
to control said display circuit to light a fifth LED when it is judged based on the content of the predetermined register of said network interface circuit that the FLP burst signal is received, which signifies that the network apparatus is in an auto-negotiation operation state, as well as when it is further judged based on the content of the register that the network apparatus corresponds to the 100 BASE-TX standard and the communication system thereof is operable in the half-duplex mode; and
to control said display circuit to light a sixth LED when it is judged based on the content of the predetermined register of said network interface circuit that the FLP burst signal is received, which signifies that the network apparatus is in an auto-negotiation operation state, as well as when it is further judged based on the content of the register that the network apparatus corresponds to the 100 BASE-TX standard and the communication system thereof is operable in the full-duplex mode.

3. A signal confirming/judging device for LAN according to any one of claim 1 and claim 2, further comprising:
a first connector including a plurality of pins, a second connector including a plurality of pins, and changeover switches, and
wherein the plural pins of said first connector and the plural pins of said second connector are wired/connected to shift between a straight connection and a cross connection via said changeover switches,
wherein the straight connection connects predetermined pins defined in advance as pins for a transmitting signal in said first and said second connectors with each other while connecting predetermined pins defined in advance as pins for a receiving signal in said first connector and said second connector with each other,
wherein the cross connection connects the predetermined pins defined in advance as the pins for a transmitting signal in said first connector and the predetermined pins defined in advance as the pins for a receiving signal in said second connector while connecting the predetermined pins defined in advance as the pins for a receiving signal in said first connector and the predetermined pins defined in advance as the pins for a transmitting signal in said second connector,
wherein terminal resistors are provided respectively between each of the predetermined pins which are defined in advance as the pins for a transmitting signal in said first or said second connector and between each of the predetermined pins which are defined in advance as the pins for a receiving signal in said first or said second connector so that connection states of the terminal resistors are changeable by opening/closing the terminal switches which are connected in series with the terminal resistors, and
wherein respective waveform observing terminals are connected to respective wirings which connect the plural pins of said first connector and the plural pins of said second connector respectively.

4. A signal confirming/judging device for LAN according to claim 3,
wherein said first connector and said second connector are wired/connected in a manner in which the input signal is inputted via said first connector or said second connector in said network interface circuit.

5. A signal confirming/judging method for LAN for confirming/judging an operation mode of each of apparatuses constituting a LAN based on a predetermined signal which is outputted before data is transmitted/received among the apparatuses constituting the LAN and which is used in confirming a mutual operation state, the method comprising the steps of:
inputting the signal outputted from the apparatus constituting the LAN to judge whether the output signal is a normal link pulse signal, an idle signal, or an FLP burst signal;
performing a predetermined first display when it is judged that the output signal is the normal link pulse signal, which signifies that the apparatus corresponds to a 10 BASE-T standard and a communication system thereof is in a half-duplex mode fixed state;
performing a predetermined second display when it is judged that the output signal is the idle signal, which signifies that the apparatus corresponds to a 100 BASE-TX standard and the communication system thereof is in the half-duplex fixed state;
further judging a mode in which the apparatus is operable based on a content of the FLP burst signal when it is judged that the output signal is the FLP burst signal;
performing, when it is judged based on a judgment made in said step of judging that the apparatus corresponds to the 10 BASE-T standard and the communication system thereof is operable in the half-duplex mode, a predetermined third display which indicates that the apparatus is operable in this operation mode in auto-negotiation;
performing, when it is judged that the apparatus corresponds to the 10 BASE-T standard and the communication system thereof is operable in a full-duplex mode, a predetermined fourth display which indicates that the apparatus is operable in this operation mode in the auto-negotiation;
performing, when it is judged that the apparatus corresponds to the 100 BASE-TX standard and the communication system thereof is operable in the half-duplex mode, a predetermined fifth display which indicates that the apparatus is operable in this operation mode in the auto-negotiation; and
performing, when it is judged that the apparatus corresponds to the 100 BASE-TX standard and the communication system thereof is operable in the full-duplex mode, a predetermined sixth display which indicates that the apparatus is operable in this operation mode in the auto-negotiation.

6. A recording medium in which a plurality of computer readable instructions are recorded, the plural instructions being readable by a microcomputer in a signal confirming/judging device for LAN comprising: a network interface circuit structured to allow a predetermined signal, which is outputted before data is transmitted/received among apparatuses constituting the LAN and is used in confirming a mutual operation state, to be inputted therein, and to set a binary data in a predetermined register according to a type of a signal inputted therein when the predetermined signal is inputted; and the microcomputer for performing processing of judging an operation mode of each of the apparatuses which constitute the LAN based on content of the predetermined register of the network interface circuit, and being operable to cause the processing of judging the operation mode of each of the apparatuses constituting the LAN to be performed, the recording medium comprising:
instruction means operable to cause the microcomputer to read the content of the predetermined register of the network interface circuit;
instruction means operable to cause judgment to be made based on the content of the register whether the signal outputted from the apparatus constituting the LAN is a normal link pulse signal, an idle signal, or an FLP burst signal;
instruction means operable to cause a signal to be outputted outside, the signal indicating that the apparatus constituting the LAN corresponds to a 10 BASE-T standard and a communication system thereof is in a half-duplex mode fixed state when the signal outputted from the apparatus constituting the LAN is judged to be the normal link pulse signal;
instruction means operable to cause a signal to be outputted outside, the signal indicating that the apparatus constituting the LAN corresponds to a 100 BASE-TX standard and the communication system there of is in the half-duplex mode fixed state when the signal outputted from the apparatus constituting the LAN is judged to be the idle signal;
instruction means operable to further cause judgment of a mode in which the apparatus constituting the LAN is operable to be made based on the content of the predetermined register when the signal outputted from the apparatus constituting the LAN is judged to be the FLP burst signal;
instruction means operable to cause, when the apparatus constituting the LAN is judged to correspond to the 10 BASE-T standard and the communication system thereof is judged to be operable in the half-duplex mode, a signal to be outputted outside, the signal indicating that the apparatus constituting the LAN is operable in this operation mode in auto-negotiation;
instruction means operable to cause, when the apparatus constituting the LAN is judged to correspond to the 10 BASE-T standard and the communication system thereof is judged to be operable in a full-duplex mode, a signal to be outputted outside, the signal indicating that the apparatus constituting the LAN is operable in this operation mode in the auto-negotiation;
instruction means operable to cause, when the apparatus constituting the LAN is judged to correspond to the 100 BASE-TX standard and the communication system thereof is judged to be operable in the half-duplex mode, a signal to be outputted outside, the signal indicating that the apparatus constituting the LAN is operable in this operation mode in the auto-negotiation; and
instruction means operable to cause, when the apparatus constituting the LAN is judged to correspond to the 100 BASE-TX standard and the communication system thereof is judged to be operable in the full-duplex mode, a signal to be outputted outside, the signal indicating that the apparatus constituting the LAN is operable in this operation mode in the auto-negotiation.
